(19) United States
(12) Patent Application Publication
(10) Pub. No.: US 2026/0059356 A1
(43) Pub. Date: Feb. 26, 2026

(54) RECOMMENDATION OF REFERENCE SIGNAL RESOURCES FOR BEAM PREDICTION

(71) Applicant: QUALCOMM Incorporated, San Diego, CA (US)

(72) Inventors: Qiaoyu LI, Beijing (CN); Wooseok NAM, San Diego, CA (US); Hamed PEZESHKI, San Diego, CA (US); Tao LUO, San Diego, CA (US); Mahmoud TAHERZADEH BOROUJENI, San Diego, CA (US)

(21) Appl. No.: 19/101,424

(22) PCT Filed: Sep. 30, 2022
(86) PCT No.: PCT/CN2022/123218

§ 371 Date: Feb. 5, 2025

(51) Int. Cl. H04W 24/08; H04L 5/00

(52) U.S. Cl. CPC H04W 24/08; H04L 5/0048

(57) ABSTRACT

Various aspects of the present disclosure generally relate to wireless communication. In some aspects, a user equipment (UE) may transmit a recommendation of a set of reference signal resources for monitoring performance of beam prediction procedures. The UE may receive a request to perform a beam prediction procedure from a network entity. The UE may perform the beam prediction procedure. The UE may receive, in association with the recommendation, auxiliary reference signals in beams that are among beam prediction targets of the beam prediction procedure. Numerous other aspects are described.

### FIELD OF THE DISCLOSURE

Aspects of the present disclosure generally relate to wireless communication and to techniques and apparatuses for recommending reference signal resources for beam prediction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communications at a user equipment (UE). The apparatus may include a memory and one or more processors coupled to the memory. The one or more processors may be configured to transmit a recommendation of a set of reference signal resources for monitoring performance of beam prediction procedures. The one or more processors may be configured to receive a request to perform a beam prediction procedure from a network entity. The one or more processors may be configured to perform the beam prediction procedure. The one or more processors may be configured to receive, in association with the recommendation, auxiliary reference signals in beams that are among beam prediction targets of the beam prediction procedure.

Some aspects described herein relate to an apparatus for wireless communications at a network entity. The apparatus may include a memory and one or more processors coupled to the memory. The one or more processors may be configured to receive a recommendation of a set of reference signal resources for a UE to use for monitoring performance of beam prediction procedures. The one or more processors may be configured to transmit a request to perform a beam prediction procedure. The one or more processors may be configured to select, based at least in part on the recommendation, auxiliary reference signals for beams that are among beam prediction targets. The one or more processors may be configured to transmit the auxiliary reference signals in the beams.

Some aspects described herein relate to a method of wireless communication performed by a UE. The method may include transmitting a recommendation of a set of reference signal resources for monitoring performance of beam prediction procedures. The method may include receiving a request to perform a beam prediction procedure from a network entity. The method may include performing the beam prediction procedure. The method may include receiving, in association with the recommendation, auxiliary reference signals in beams that are among beam prediction targets of the beam prediction procedure.

Some aspects described herein relate to a method of wireless communication performed by a network entity. The method may include receiving a recommendation of a set of reference signal resources for a UE to use for monitoring performance of beam prediction procedures. The method may include transmitting a request to perform a beam prediction procedure. The method may include selecting, based at least in part on the recommendation, auxiliary reference signals for beams that are among beam prediction targets. The method may include transmitting the auxiliary reference signals in the beams.

Some aspects described herein relate to a non-transitory computer-readable medium that stores a set of instructions for wireless communication by a UE. The set of instructions, when executed by one or more processors of the UE, may cause the UE to transmit a recommendation of a set of reference signal resources for monitoring performance of beam prediction procedures. The set of instructions, when executed by one or more processors of the UE, may cause the UE to receive a request to perform a beam prediction procedure from a network entity. The set of instructions, when executed by one or more processors of the UE, may cause the UE to perform the beam prediction procedure. The set of instructions, when executed by one or more processors of the UE, may cause the UE to receive, in association with the recommendation, auxiliary reference signals in beams that are among beam prediction targets of the beam prediction procedure.

Some aspects described herein relate to a non-transitory computer-readable medium that stores a set of instructions for wireless communication by a network entity. The set of instructions, when executed by one or more processors of the network entity, may cause the network entity to receive a recommendation of a set of reference signal resources for a UE to use for monitoring performance of beam prediction procedures. The set of instructions, when executed by one or more processors of the network entity, may cause the network entity to transmit a request to perform a beam prediction procedure. The set of instructions, when executed by one or more processors of the network entity, may cause the network entity to select, based at least in part on the recommendation, auxiliary reference signals for beams that are among beam prediction targets. The set of instructions, when executed by one or more processors of the network entity, may cause the network entity to transmit the auxiliary reference signals in the beams.

Some aspects described herein relate to an apparatus for wireless communication. The apparatus may include means for transmitting a recommendation of a set of reference signal resources for monitoring performance of beam prediction procedures. The apparatus may include means for receiving a request to perform a beam prediction procedure from a network entity. The apparatus may include means for performing the beam prediction procedure. The apparatus may include means for receiving, in association with the recommendation, auxiliary reference signals in beams that are among beam prediction targets of the beam prediction procedure.

Some aspects described herein relate to an apparatus for wireless communication. The apparatus may include means for receiving a recommendation of a set of reference signal resources for another apparatus to use for monitoring performance of beam prediction procedures. The apparatus may include means for transmitting a request to perform a beam prediction procedure. The apparatus may include means for selecting, based at least in part on the recommendation, auxiliary reference signals for beams that are among beam prediction targets. The apparatus may include means for transmitting the auxiliary reference signals in the beams.

Aspects generally include a method, apparatus, system, computer program product, non-transitory computer-readable medium, UE, mobile station, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of an artificial intelligence or machine learning based beam management, in accordance with the present disclosure.

FIG. 7 is a diagram illustrating an example of auxiliary reference signals, in accordance with the present disclosure.

FIG. 8 is a diagram illustrating an example of recommending a set of reference signal resources for auxiliary reference signals, in accordance with the present disclosure.

FIG. 9 is a diagram illustrating an example of spatial associations, in accordance with the present disclosure.

FIG. 10 is a diagram illustrating an example of spatial associations, in accordance with the present disclosure.

FIG. 11 is a diagram illustrating an example process performed, for example, by a UE, in accordance with the present disclosure.

FIG. 12 is a diagram illustrating an example process performed, for example, by a network entity, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

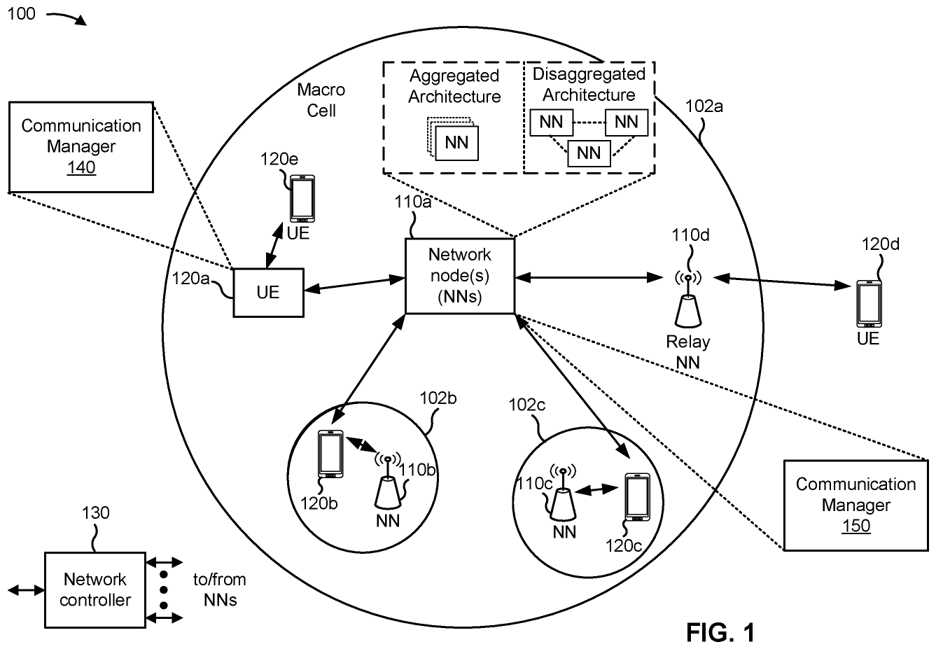

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station,” “network node,” or “network entity” may refer to one device configured to perform one or more functions, such as those described herein in connection with the network node 110. In some aspects, the terms “base station,” “network node,” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station,” “network node,” or “network entity” may refer to any one or more of those different devices. In some aspects, the terms “base station,” “network node,” or “network entity” may refer to one or more virtual base stations or one or more virtual base station functions. For example, in some aspects, two or more base station functions may be instantiated on a single device. In some aspects, the terms “base station,” “network node,” or “network entity” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a recommendation of a set of reference signal resources for monitoring performance of beam prediction procedures. The communication manager 140 may receive a request to perform a beam prediction procedure from a network entity and perform the beam prediction procedure. The communication manager 140 may receive, in association with the recommendation, auxiliary reference signals in beams that are among beam prediction targets of the beam prediction procedure. Additionally, or alternatively, the communication manager 140 may perform one or more other operations described herein.

In some aspects, a network entity (e.g., base station 110) may include a communication manager 150. As described in more detail elsewhere herein, the communication manager 150 may receive a recommendation of a set of reference signal resources for a UE to use for monitoring performance of beam prediction procedures. The communication manager 150 may transmit a request to perform a beam prediction procedure. The communication manager 150 may select, based at least in part on the recommendation, auxiliary reference signals for beams that are among beam prediction targets; and transmit the auxiliary reference signals in the beams. Additionally, or alternatively, the communication manager 150 may perform one or more other operations described herein.

As indicated above, FIG. 1 is provided as an example. Other examples may differ from what is described with regard to FIG. 1.

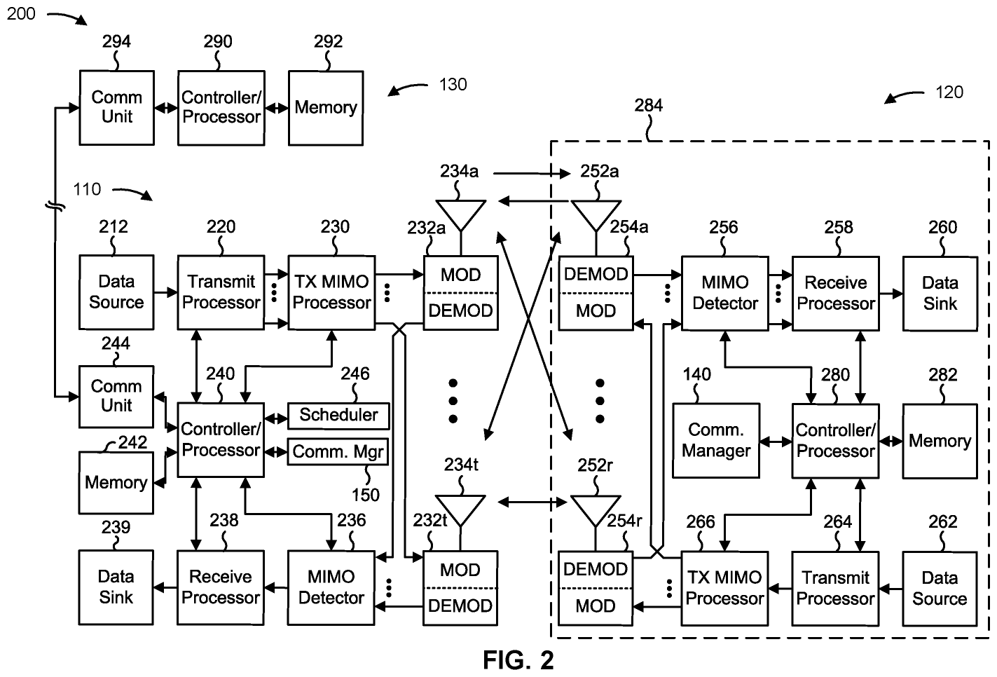

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

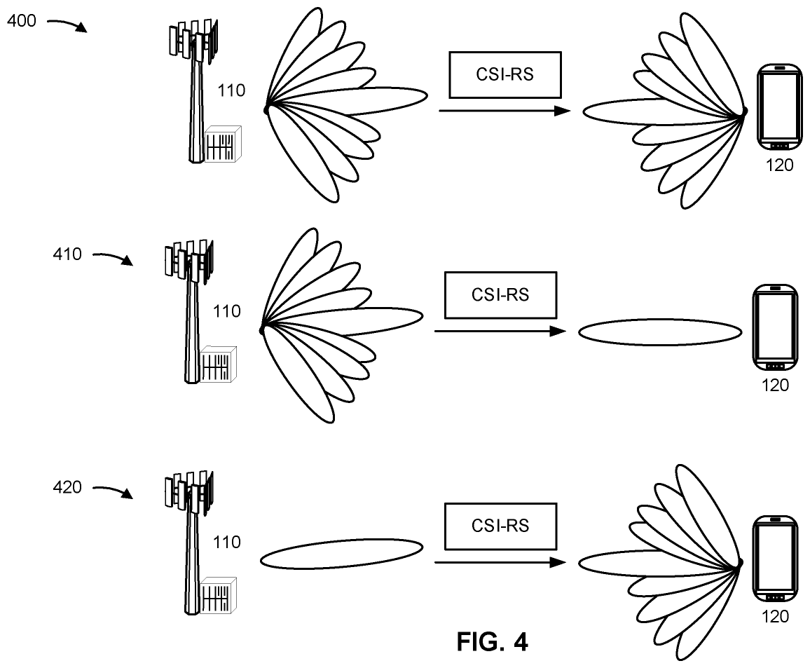

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

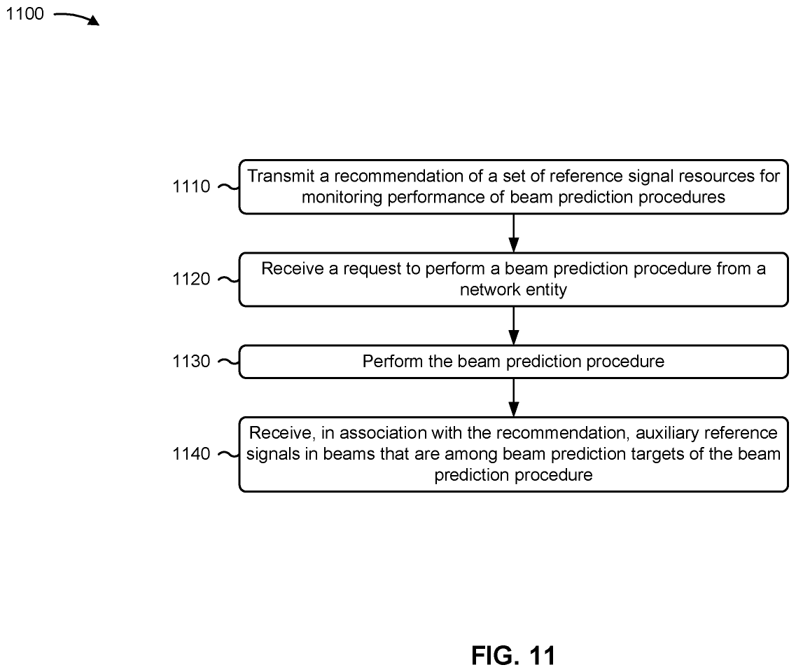

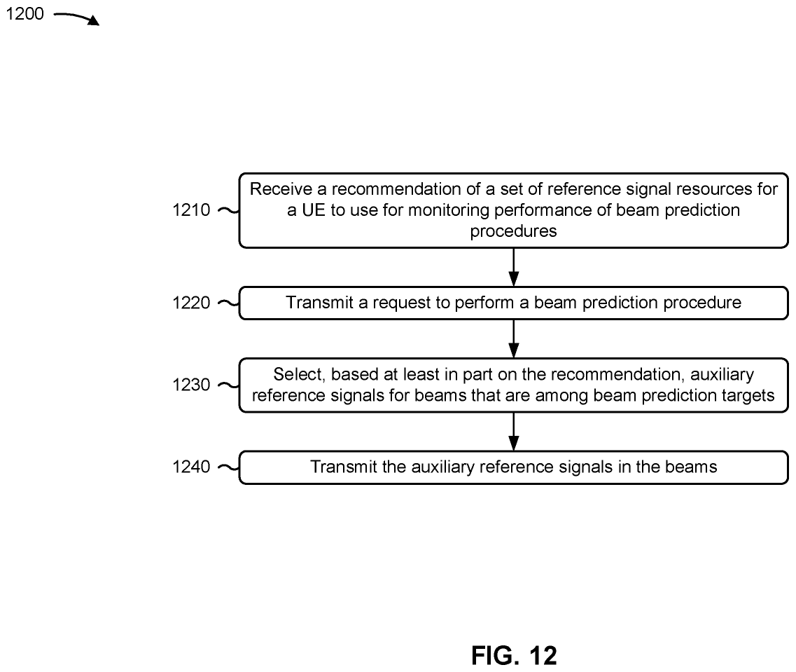

The controller/processor of a network entity (e.g., controller/processor 240 of the network node 110), the controller/processor 280 of the UE 120, and/or any other component(s) of FIG. 2 may perform one or more techniques associated with recommending reference signal resources for monitoring beam prediction performance, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for transmitting a recommendation of a set of reference signal resources for monitoring performance of beam prediction procedures; means for receiving a request to perform a beam prediction procedure from a network entity; means for performing the beam prediction procedure; and/or means for receiving, in association with the recommendation, auxiliary reference signals in beams that are among beam prediction targets of the beam prediction procedure. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for receiving a recommendation of a set of reference signal resources for a UE to use for monitoring performance of beam prediction procedures; means for transmitting a request to perform a beam prediction procedure; means for selecting, based at least in part on the recommendation, auxiliary reference signals for beams that are among beam prediction targets; and/or means for transmitting the auxiliary reference signals in the beams. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

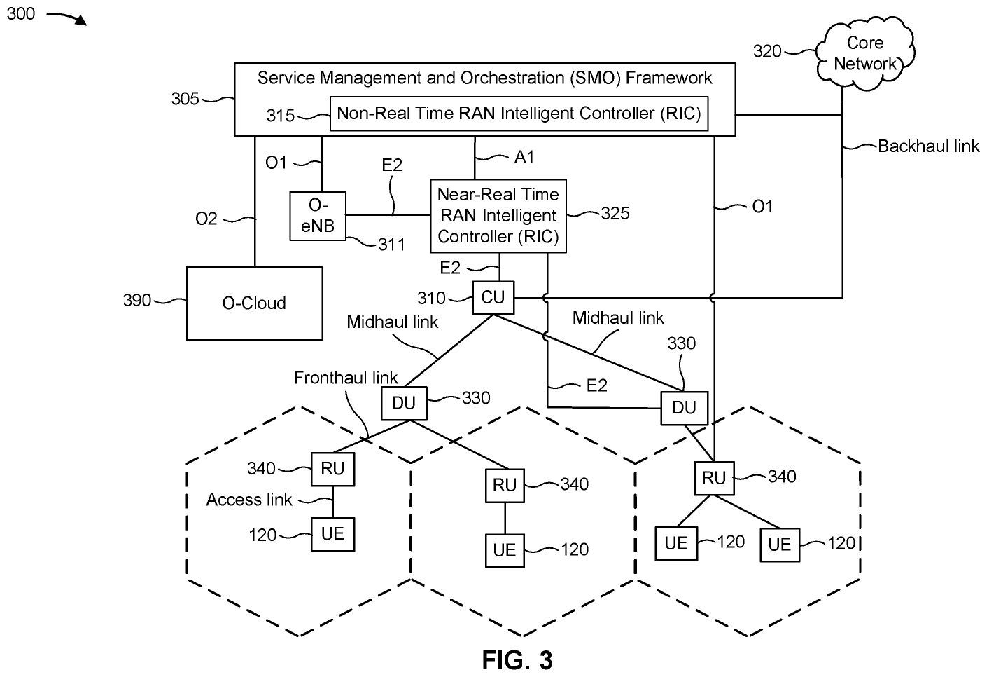

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325. In some examples, the near-RT RIC 325 may be a logical function that enables near-real-time control and optimization of O-RAN elements and resources via fine-grained data collection and actions over an E2 interface. The Near-RT RIC 325 may be collocated with the RAN or network entity to provide the real-time processing, such as online ML training or near real time ML inference. The non-RT RIC 315 may be a logical function that enables non-real-time control and optimization of RAN elements and resources, AI/ML workflow including model training and updates, and policy-based guidance of applications/features in near-RT RIC 325, as well as ML inference with less latency specification. The non-RT RIC 315 may be located further from the RAN or network node, such as on a cloud-based server or on an edge server.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of beam management procedures, in accordance with the present disclosure. As shown in FIG. 4, examples 400, 410, and 420 include a UE 120 in communication with a network entity (e.g., network node 110) in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using channel state information (CSI) reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHZ, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

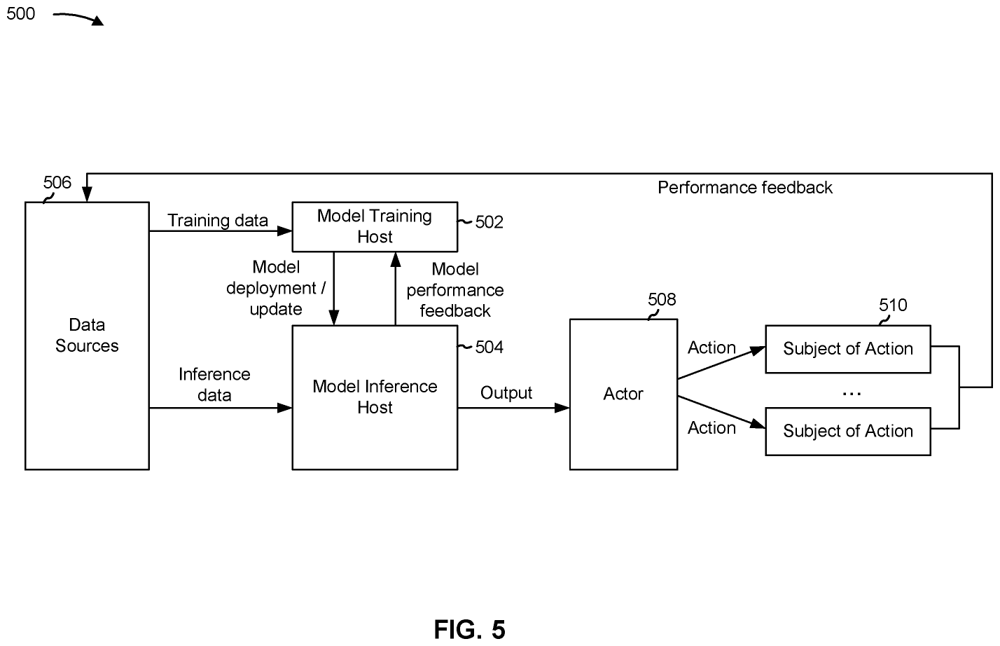

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, a network entity, a base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-) configuration or a beam switching indication to the subject of action 510. The actor 508 may modify its Tx/Rx beam based on the beam (re-) configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

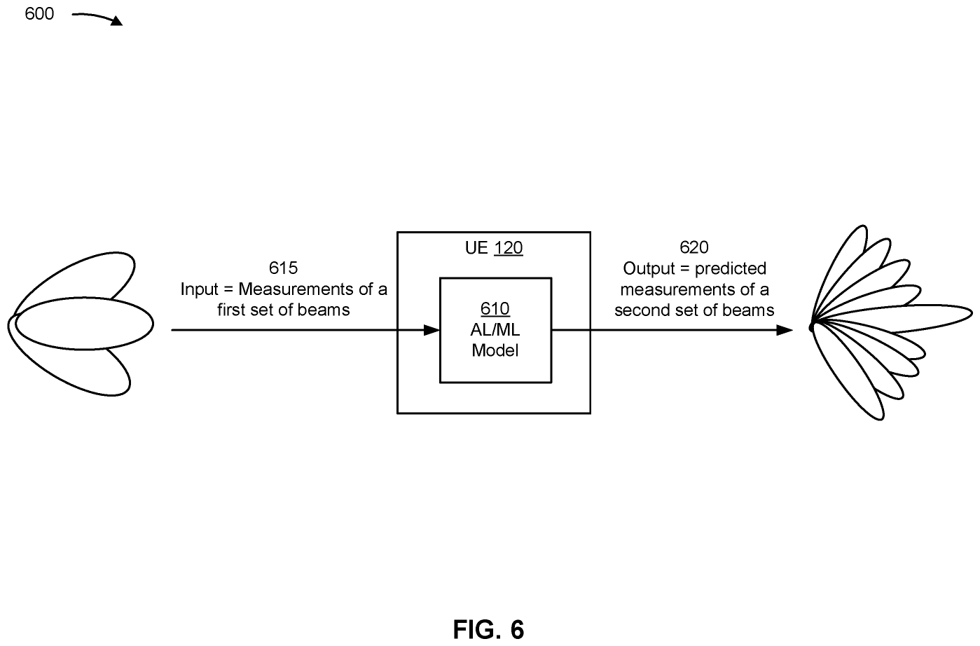

FIG. 6 is a diagram illustrating an example 600 of an AI/ML based beam management, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals values respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedure, beam failure and/or beam blockage predictions, and/or radio link failure predictions, among other examples. This may lead to better management accuracy without excessive beam sweeping.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

As described above, to perform the predictions described herein, the UE 120 and/or the AI/ML model 610 may expect information associated with the first set of beams and/or the second set of beams in order to accurately perform the predictions. For example, the UE 120 and/or the AI/ML model 610 may use information such as a beam direction (e.g., spatial direction), beam width, beam shape, and/or other characteristics of the respective beams from the first set of beams and/or the second set of beams to accurately perform the predictions described above. However, this information may be associated with beamforming techniques performed at a network entity (e.g., network node 110). Therefore, the network node 110 may transmit, and the UE 120 may receive the information (e.g., a beam direction (e.g., spatial direction), beam width, beam shape, and/or other characteristics of the respective beams from the first set of beams and/or the second set of beams). However, this may consume significant signaling overhead, especially in cases where the network node 110 may dynamically change beamforming techniques or shapes (e.g., thereby requiring another transmission of the information described above). Further, explicit indications of the beamforming techniques performed at a network node 110 may expect detailed disclosures of proprietary or confidential information. Therefore, in some cases, a network node 110 may not provide explicit indications of some, or all, of the information needed by the UE 120 to accurately perform the predictions described above. As a result, AI/ML predictions performed by the UE 120 may be degraded because the UE 120 may not have access to information of beam characteristics or shapes of beams associated with the AI/ML predictions.

In some aspects, there may be connections between resources for predictive beam management. For example, the UE 120 may receive an indication of a first set of resources and a second set of resources and an indication of one or more connections between the first set of resources and the second set of resources. The one or more connections may include a connection associated with a resource, included in the first set of resources or the second set of resources, that is defined with respect to one or more resources included in a different set of resources from the first set of resources or the second set of resources. In other words, the connections may be implicit connections defining beam characteristics associated with a given resource with respect to beams associated with other resources(s) that are included in a different set. In some examples, the connection described herein may be referred to as an implicit connection, an association, a relation, a relationship, a correspondence, a mapping, and/or a link, among other examples. The connection may indicate a relationship between a first spatial direction or a first beam associated with the resource and second spatial directions or second beams of the one or more resources included in the different set of resources. The first set of resources may be channel measurement resources for a CSI report and the second set of resources may be resources that are not to be actually measured by the UE 120 (e.g., nominal resources). For example, the first set of resources may be associated with Set B beams and the second set of resources may be associated with Set A beams. In some aspects, the connections may be graph-based connections or may be linear combinations.

The UE 120 may transmit a CSI report indicating measurement values associated with the first set of resources and the second set of resources. A first one or more measurement values, from the measurement values, associated with the first set of resources may be measured by the UE 120. A second one or more measurement values, from the measurement values, associated with the second set of resources may be predicted by the UE 120 based at least in part on the first one or more measurement values and the one or more connections. In other words, the UE 120 may use the connections between the first set of resources and the second set of resources to obtain beam characteristics or beam shapes associated with the first set of resources and the second set of resources. The UE 120 may use the beam characteristics or beam shapes associated with the first set of resources and the second set of resources to perform one or more AI/ML predictions associated with the first set of resources and the second set of resources.

In some aspects, one or more resources included in the second set of resources may be used for a transmission configuration indicator (TCI) state indication. Additionally, or alternatively, one or more resources included in the second set of resources may be used by the UE 120 as a source reference for a quasi-co-location (QCL) source (e.g., even though the UE 120 has not actually received and/or measured signal(s) via the second set of resources).

Beam prediction at the network node 110 can utilize more powerful computation capabilities than at the UE 120. The network node 110 also has access to historical or location-wise L1 report distributions and may access other UE feedback and location information. The network node 110 may also be aware of transmit beam shapes (e.g., SSB, CSI-RS) and pointing directions. However, only the strongest beams are reported from the UE 120 and it is hard to know the receive beams used to derive the L1 reports or CSI feedback. The UE feedback may be quantized and it may be difficult to determine the UE's orientation or rotation status.

Beam prediction at the UE 120 may benefit from instant access to filtered measurements of all beams. The UE 120 has access to the receive beams used to derive the measurements. The measurements may be either raw or quantized. The UE 120 may be aware of or able to predict its own orientation and rotation status. Accordingly, the UE 120 may utilize an ML model to predict one or more beam parameters for a predicted beam group based on a nominal reference signal group. In this regard, the ML model executed by the UE 120 may utilize measurements and/or other information (e.g., UE mobility, UE location) associated with the nominal reference signal group and/or previously acquired data to determine one or more beam parameters (e.g., predicted beam measurements, predicted beam ranking order) for the predicted beam group.

The predicted beam group may be associated with a future reference signal monitoring occasion (e.g., reference signal monitoring occasions associated with nominal reference signal groups). The predicted beam groups may be associated with a time period between reference signal monitoring occasions. The predicted beam groups may be associated with time periods between reference signal monitoring occasions where reference signal transmissions are omitted but would occur if a standard reference signal periodicity was being used.

As indicated above, FIG. 6 is provided as an example. Other examples may differ from what is described with regard to FIG. 6.

An auxiliary reference signal may be a reference signal that is transmitted to assist with monitoring beam prediction performance. The auxiliary reference signal may have an auxiliary or supporting role in beam prediction. Auxiliary reference signals may be included in reference signal resources (e.g., time, frequency, beam configuration, beam direction) and may be part of an auxiliary reference signal group. The network node 110 may periodically transmit one or more auxiliary reference signal groups of beams during an ML model evaluation period. In some examples, the auxiliary reference signal groups may be spaced from a nominal reference signal group by a period (e.g., 5 ms, 10 ms, 20 ms). The auxiliary reference signal groups may be utilized by the UE to evaluate the performance of the ML model. For example, the UE 120 may utilize the ML model to predict one or more beam parameters for a predicted beam group based on a nominal reference signal group. Each predicted beam group may be associated with an auxiliary reference signal group. In this regard, one or more measurements for the auxiliary reference signal group that the predicted beam group is associated with may be utilized to evaluate the performance of the ML model. For example, measurements for the auxiliary reference signal group may be compared to measurements of predicted beams of the ML model and/or compared to predicted measurements of the predicted beams of the ML model to evaluate the performance of the ML model. The comparison may indicate that an ML model failure instance (MFI) has occurred. If a sufficient number of MFIs occurs (e.g., beamPredictionErrorCount) within a period of time (e.g., based on an ML model failure detection timer, beamPredictionMonitoringTimer), then the ML model may be indicated as having failed.

The UE 120 may be radio resource control (RRC) configured with one or multiple reference signal resources to be transmitted based on the same spatial transmit filter. The UE 120 may predict an associated L1-RSRP report, an L1 signal-to-interference-plus-noise ratio (SINR), a rank indicator (RI), a precoding matrix indicator (PMI), a CQI, and/or a layer indicator (LI) for a beam associated with the reference signal resources. Auxiliary reference signals for performance monitoring may be linked through SSBs and/or CSI-RSs based on network node 110 indications. However, different UEs may prefer or support different quantities, periodicities, or types of auxiliary reference signals. Relying solely on network node configurations for auxiliary reference signal resources may consume additional signaling resources because of redundant downlink reference signal overhead. For a UE with reliable prediction results, such auxiliary reference signals may not even be needed.

In some aspects, when the UE 120 sees a decreasing beam prediction confidence level, the UE 120 may proactively request that the network node 110 transmit auxiliary reference signals. According to various aspects described herein, the UE 120 may recommend a set of reference signal resources for the auxiliary reference signals. The UE may be in a better position to select the resources for the auxiliary reference signals. The set of reference signal resources may be associated with parameters that include, for example, a quantity of reference signal resources in a reference signal resource set (or multiple resource sets), a periodicity of reference signal resources in a resource set, or a type of reference signal resource (e.g., SSB, CSI-RS, quantity of ports in each CSI-RS). A configured periodicity of auxiliary reference signal resources may be longer than a periodicity of reported reference signal resources. The parameters may also include a frequency domain density of reference signal resources within a resource set, such as a quantity of resource elements (REs) per physical resource block (PRB) and/or a PRB density in a bandwidth part (BWP). The UE 120 may also recommend a timer value and/or a count threshold. The UE 120 may transmit such a recommendation during initial access (e.g., as a UE capability, minimum values) and/or transmit dynamic recommendations (e.g., updates) based at least in part on real time observations of AI/ML output.

In some aspects, the UE 120 may recommend spatial associations between the auxiliary reference signal resources and beam prediction targets regarding a specific beam prediction procedure. A spatial association may associate one or more first reference signal resources that share a beam direction and/or angular spread with one or more second reference signal resources.

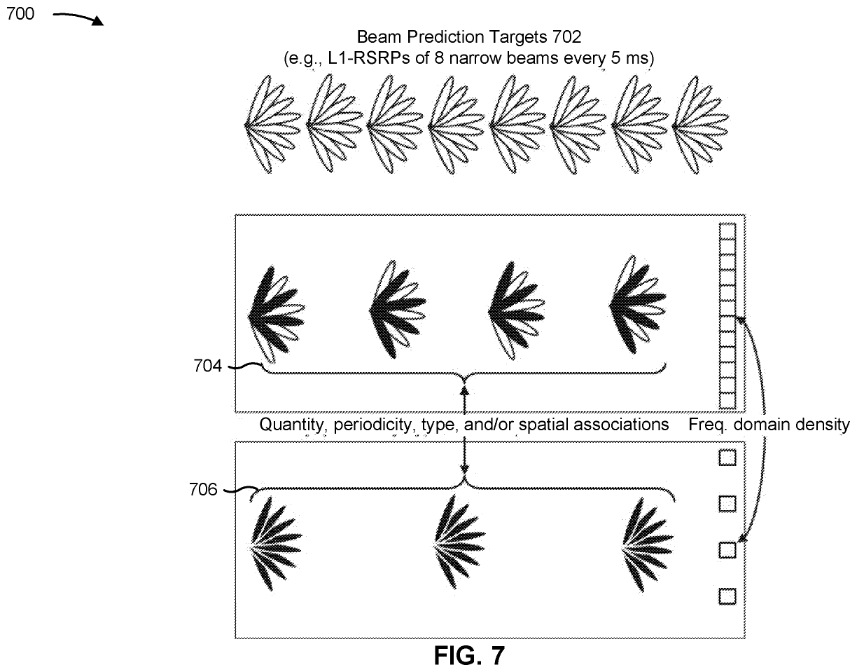

FIG. 7 is a diagram illustrating an example 700 of auxiliary reference signals, in accordance with the present disclosure.

Example 700 shows beam prediction targets 702 of a beam prediction procedure, which may be reference signal resources in multiple target beam directions (e.g., 8 narrow beams every 5 milliseconds (ms)). A UE may predict beams within the beam prediction targets 702. The UE may measure a performance of some or all of the beam prediction targets 702 by measuring auxiliary reference signals (e.g., L1-RSRP measurements) that are received in beams that are among the beam prediction targets 702.

Example 700 shows a first set of auxiliary reference signals 704 in reference signal resources that are a subset of the beam prediction targets 702 and that are in every other beam prediction target of a beam sweep. Beam sweeps of auxiliary signals may occur according to a first periodicity. The next beam sweep may use beam prediction targets that were not used in the last beam sweep occasion.

Example 700 also shows a second set of auxiliary reference signals 706 that are transmitted in reference signal resources that are in all of the beam prediction targets 702. The beam sweeps may occur according to a second periodicity, which is longer than the first periodicity in example 700.

In some aspects, the UE may recommend a set of reference signal resources for the auxiliary reference signals. The recommendation may indicate specific reference signal resources (e.g., which beam prediction targets). The recommendation may also indicate parameters associated with the set of reference signal resources, such as a quantity of reference signals in the set, a periodicity of the reference signal resources, a type of the reference signal resources, and/or spatial associations between beam prediction targets 702 and the auxiliary reference signals. The spatial associations may be based at least in part on a quantity of beam prediction targets having a greatest signal strength, such as a top K beams. The recommendation may also indicate a frequency domain density, such as REs per PRB and/or a PRB density (e.g., PRBs per frequency band of specified size) in a BWP.

As indicated above, FIG. 7 is provided as an example. Other examples may differ from what is described with regard to FIG. 7.

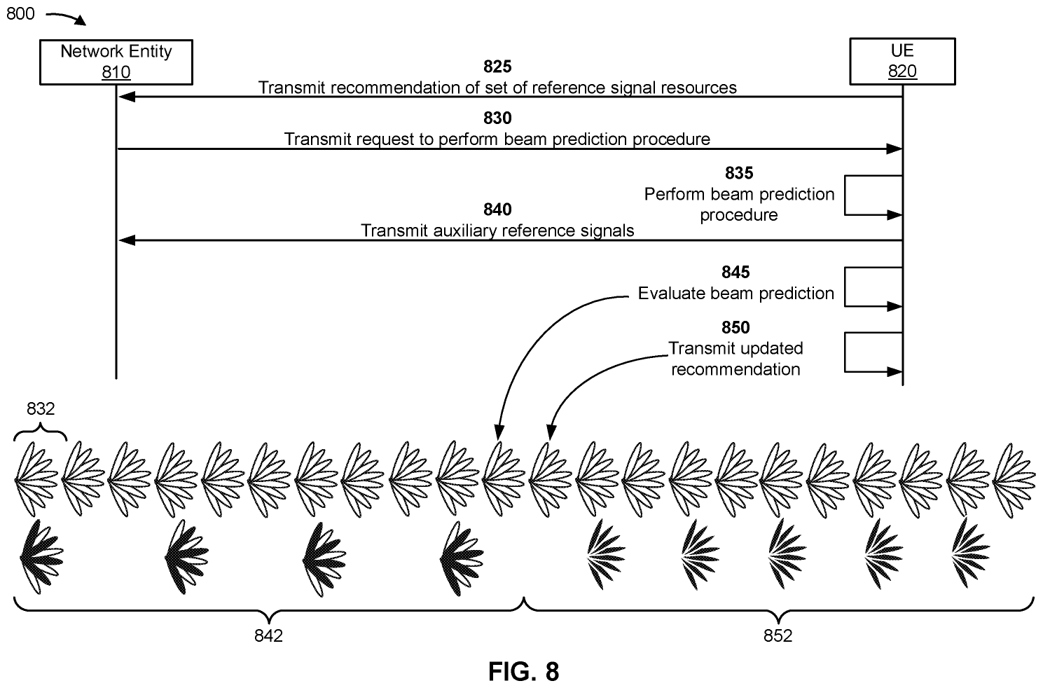

FIG. 8 is a diagram illustrating an example 800 of recommending a set of reference signal resources for auxiliary reference signals, in accordance with the present disclosure. As shown in FIG. 8, a network entity 810 (e.g., network node 110, a CU, a DU, and/or an RU) may communicate with a UE 820 (e.g., UE 120). In some aspects, the network entity 810 and the UE 820 may be part of a wireless network (e.g., the wireless network 100). The UE 820 and the network entity 810 may have established a wireless connection prior to operations shown in FIG. 8.

As shown by reference number 825, the UE 820 may transmit a recommendation of a set of reference signal resources for monitoring performance of beam prediction procedures. The recommendation may be transmitted in a MAC CE or in uplink control information (UCI). The UE 820 may transmit the recommendation during initial access. As shown by reference number 830, the network entity 810 may transmit a request for the UE 820 to perform a beam prediction procedure. The beam prediction procedure may include beam predictions for beam prediction targets 832.

As shown by reference number 835, the UE 820 may perform the beam prediction procedure. This may include using an ML model to predict a beam to be selected for transmission. In some aspects, the resources for the beam prediction targets 832 may be channel measurement resources (CMRs) for CSI reporting. The CMRs may include actual CMRs that are transmitted by the network entity 810 or virtual CMRs, which are nominal or logical resources that are used for beam management but are not transmitted by the network entity 810.

As shown by reference number 840, the network entity 810 may transmit a first group of auxiliary reference signals (e.g., SSBs, CSI-RSs) in beams that are among the beam prediction targets. Example 800 shows the first group of auxiliary reference signals 842 (dark beams). By default, the network entity 810 may transmit the first group of auxiliary reference signals 842 using a first periodicity and a first frequency domain density (e.g., identical to the UE capability indicated during initial access). Each auxiliary reference signal resource's beam pointing direction and beam width may be identical to a first set of virtual resources.

As shown by reference number 845, the UE 820 may evaluate the beam prediction. This may include comparing beam predication targets and measurement results of the auxiliary reference signals. If a difference between measurements (e.g., RSRP, SINR) satisfies a threshold (e.g., maximum RSRP difference or SINR difference), the UE 820 may determine that a confidence in the beam prediction has decreased. For example, the UE 820 may observe a decreased confidence level associated with predicted L1-RSRPs or L1-SINRs for one or more beams. As shown by reference number 850, the UE 820 may transmit an updated recommendation. This may be a result of the decrease of the confidence level satisfying a confidence threshold.

The updated recommendation may indicate a second set of reference signal resources (e.g., different than the first set of reference signal resources). The second set of reference signal resources may be associated with a second periodicity (e.g., less than the first periodicity) and a second frequency domain density (e.g., less than the first frequency domain density). The UE 820 may transmit the updated recommendation in a MAC CE or in UCI. The UE 820 may transmit the update recommendation with a CSI report. The updated recommendation may include information about how the beam predictions compare (e.g., metric, failure indication, successful indication) to the first group of auxiliary reference signals 842. The updated recommendation may include a CSI report setting identifier (ID) associated with the CSI report for the beam prediction. The network entity 810 may transmit a second group of auxiliary reference signals 852 (dark beams) using the second set of reference signal resources.

The UE 820 may have more information than the network entity 810 with respect to resource selection for beam prediction monitoring. By providing recommendations, including updated recommendations, for reference signal resources for auxiliary reference signals, the UE 820 may improve beam prediction evaluation. This may improve communications, which conserves power and signaling resources. The UE 820 may also reduce the quantity of auxiliary reference signals that are transmitted when appropriate in order to conserve signaling resources.

As indicated above, FIG. 8 is provided as an example. Other examples may differ from what is described with regard to FIG. 8.

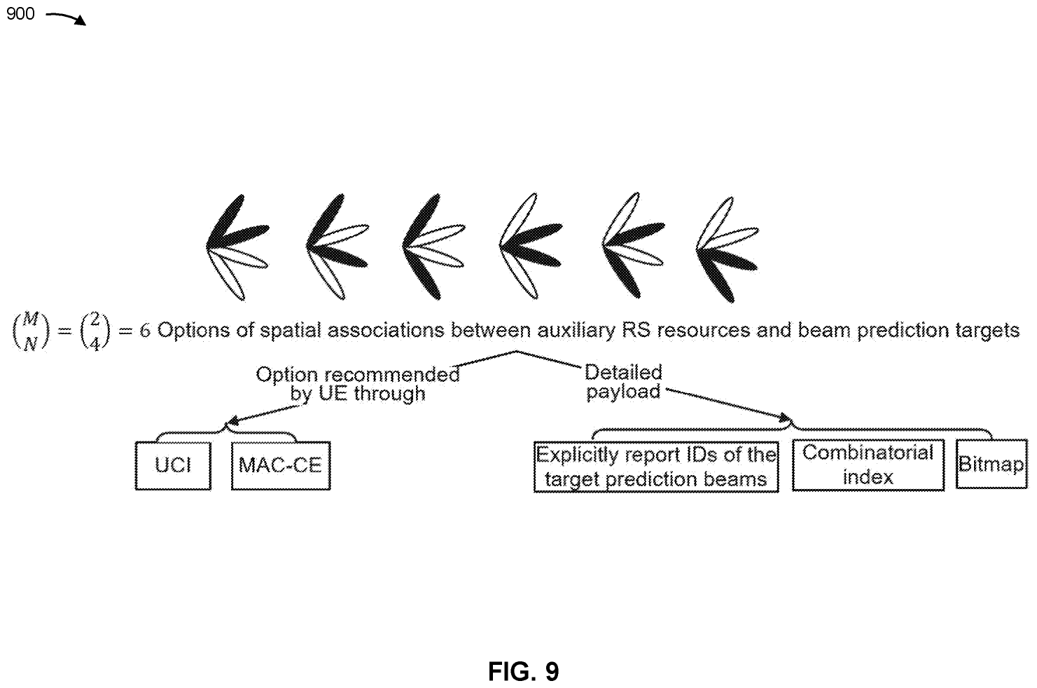

FIG. 9 is a diagram illustrating an example 900 of spatial associations, in accordance with the present disclosure.

In some aspects, there may be spatial associations between auxiliary reference signals and beam prediction targets (or target prediction beams). This may include selecting resources (e.g., beams) from among the beam prediction targets and linking selected resources (e.g., selected beams) to auxiliary reference signals. The UE 820 may recommend spatial associations based at least in part on a specific UE-based beam prediction procedure comprising N beam prediction targets. For example, the UE 820 may be further activated with a CSI report to report the top K strongest predicted L1-RSRPs associated with the N beam prediction targets. By default, the UE 820 may not expect to receive auxiliary reference signal resources associated with the beam prediction procedure. However, the UE 820 may use a MAC CE or UCI to request auxiliary reference signal resources associated with a specified quantity of the N beam prediction targets. The MAC CE may include a CSI report setting ID associated with the beam prediction procedure, as well as M IDs of the N beam prediction targets. The remaining options for UCI may also be used by a MAC CE. Similar to the MAC CE, UCI may include the CSI report with the M IDs of the N beam prediction targets, a value of M+combinatorial index

$$( \begin{matrix}M \\ N\end{matrix} ) ,$$

or a bitmap associated with the N beam prediction targets, such that M≤N. Example 900 shows 6 options of spatial associations, according to the combinatorial index, that may be recommended via a MAC CE or UCI and the options may include a payload of IDs, the combinatorial index, or a bitmap.

The network entity 810 may then request, and the UE 820 may expect to receive, M auxiliary reference signal resources whose transmit spatial filters may be identical to the M beam prediction targets requested from the UE 820. Other parameters, such as described above, may be recommended by the UE 820. A maximum value of M may be further reported as a UE capability during initial access, which may impact the MAC CE/UCI payload size for reporting the value of M.

As indicated above, FIG. 9 is provided as an example. Other examples may differ from what is described with regard to FIG. 9.

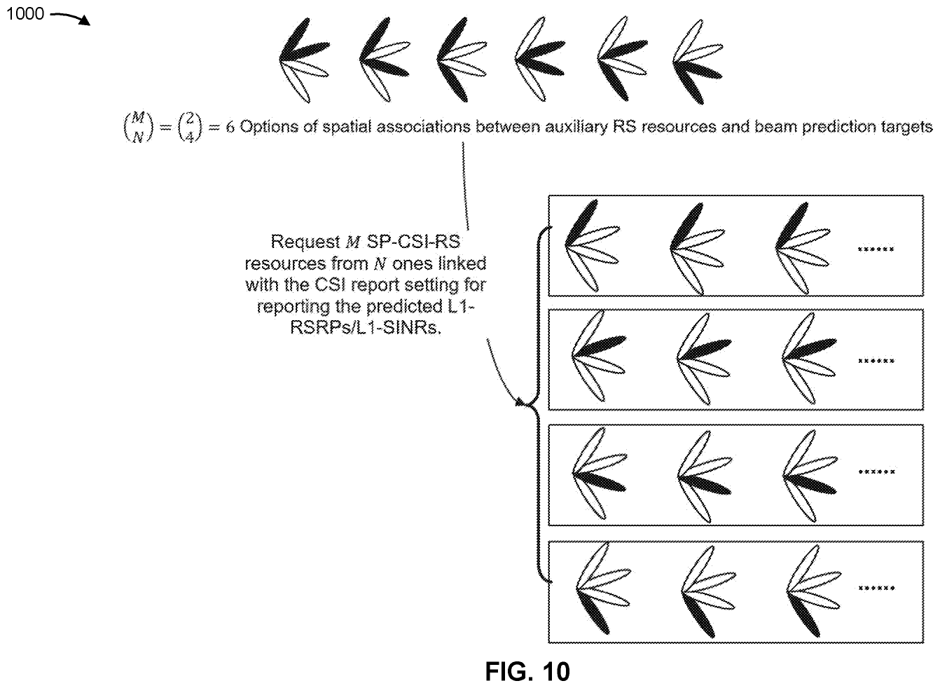

FIG. 10 is a diagram illustrating an example 1000 of spatial associations, in accordance with the present disclosure.

Example 1000 shows 4 sets of reference signal resources requested for auxiliary reference signals, where each set is a subset of the beam prediction targets. The set of reference signal resources may vary over time based at least in part on an SP CSI-RS configuration.

In some aspects, the beam prediction targets may be associated (e.g., via spatial associations) with semi-persistent (SP) CSI-RSs. The set of reference signal resources may be a subset of the SP CSI-RSs. The UE 820 may request (e.g., via MAC CE or UCI) M SP CSI-RS resources from N beam prediction targets linked with a CSI report setting for reporting predicted L1-RSRPs and/or L1-SINRs. In the MAC CE or UCI, the UE 820 may also request updated periodicities or frequency domain densities associated with one or more of the N SP CSI-RS resources. Each SP CSI-RS resource may be expected to include an identical transmit spatial filter as a specified beam prediction target of the N beam prediction targets.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120, UE 820) performs operations associated with recommending reference signal resources for monitoring beam prediction performance.

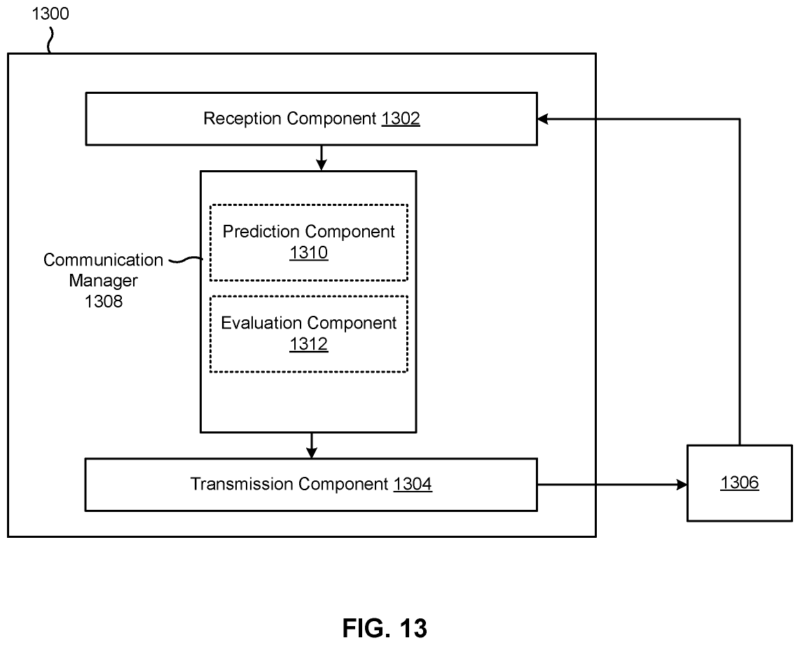

As shown in FIG. 11, in some aspects, process 1100 may include transmitting a recommendation of a set of reference signal resources for monitoring performance of beam prediction procedures (block 1110). For example, the UE (e.g., using communication manager 1308 and/or transmission component 1304 depicted in FIG. 13) may transmit a recommendation of a set of reference signal resources for monitoring performance of beam prediction procedures, as described above.

As further shown in FIG. 11, in some aspects, process 1100 may include receiving a request to perform a beam prediction procedure from a network entity (block 1120). For example, the UE (e.g., using communication manager 1308 and/or reception component 1302 depicted in FIG. 13) may receive a request to perform a beam prediction procedure from a network entity, as described above.

As further shown in FIG. 11, in some aspects, process 1100 may include performing the beam prediction procedure (block 1130). For example, the UE (e.g., using communication manager 1308 and/or prediction component 1310 depicted in FIG. 13) may perform the beam prediction procedure, as described above.

As further shown in FIG. 11, in some aspects, process 1100 may include receiving, in association with the recommendation, auxiliary reference signals in beams that are among beam prediction targets of the beam prediction procedure (block 1140). For example, the UE (e.g., using communication manager 1308 and/or reception component 1302 depicted in FIG. 13) may receive, in association with the recommendation, auxiliary reference signals in beams that are among beam prediction targets of the beam prediction procedure, as described above.

Process 1100 may include additional aspects, such as any single aspect or any combination of aspects described below and/or in connection with one or more other processes described elsewhere herein.

In a first aspect, the recommendation includes a quantity of reference signal resources in the set of reference signal resources.

In a second aspect, alone or in combination with the first aspect, the recommendation includes a periodicity of reference signal resources in the set of reference signal resources.

In a third aspect, alone or in combination with one or more of the first and second aspects, the recommendation includes a frequency domain density of reference signal resources in the set of reference signal resources.

In a fourth aspect, alone or in combination with one or more of the first through third aspects, the recommendation includes a type of reference signal resources in the set of reference signal resources.

In a fifth aspect, alone or in combination with one or more of the first through fourth aspects, transmitting the recommendation includes transmitting the recommendation with UE capability information during an initial access procedure.

In a sixth aspect, alone or in combination with one or more of the first through fifth aspects, the recommendation includes spatial associations between beam prediction targets and the auxiliary reference signals.

In a seventh aspect, alone or in combination with one or more of the first through sixth aspects, the spatial associations are based at least in part on a quantity of beam prediction targets having a greatest signal strength (e.g., greatest RSRP).

In an eighth aspect, alone or in combination with one or more of the first through seventh aspects, the beam prediction targets are associated with SP CSI-RSs.

In a ninth aspect, alone or in combination with one or more of the first through eighth aspects, the set of reference signal resources are a subset of SP CSI-RSs.

In a tenth aspect, alone or in combination with one or more of the first through ninth aspects, process 1100 includes comparing beam predication targets and measurement results of the auxiliary reference signals, and transmitting an updated recommendation based at least in part on a result of the comparing.

In an eleventh aspect, alone or in combination with one or more of the first through tenth aspects, transmitting the updated recommendation includes transmitting the updated recommendation via a MAC CE or UCI.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., network node 110, network entity 810) performs operations associated with using recommended reference signal resources for reference signals used for monitoring beam prediction performance.

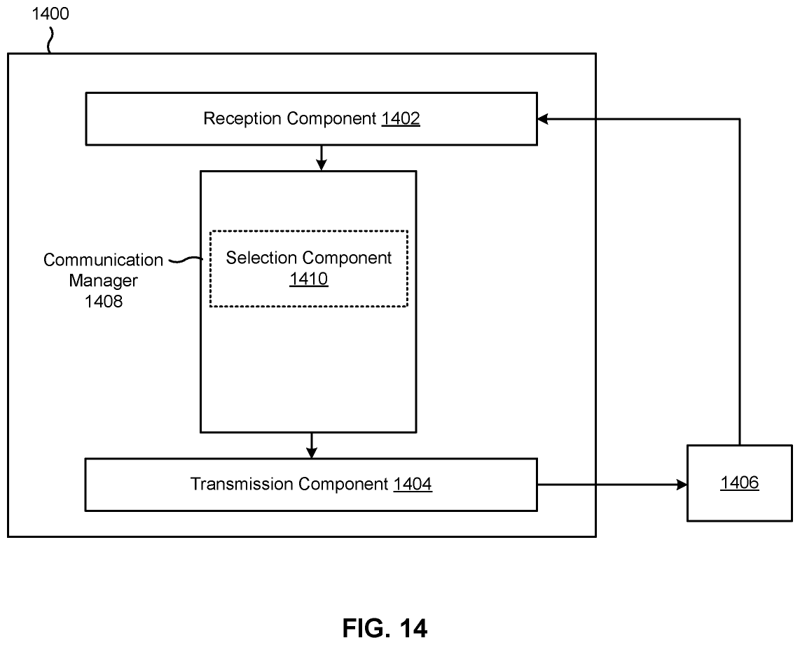

As shown in FIG. 12, in some aspects, process 1200 may include receiving a recommendation of a set of reference signal resources for a UE to use for monitoring performance of beam prediction procedures (block 1210). For example, the network entity (e.g., using communication manager 1408 and/or reception component 1402 depicted in FIG. 14) may receive a recommendation of a set of reference signal resources for a UE to use for monitoring performance of beam prediction procedures, as described above.

As further shown in FIG. 12, in some aspects, process 1200 may include transmitting a request to perform a beam prediction procedure (block 1220). For example, the network entity (e.g., using communication manager 1408 and/or transmission component 1404 depicted in FIG. 14) may transmit a request to perform a beam prediction procedure, as described above.

As further shown in FIG. 12, in some aspects, process 1200 may include selecting, based at least in part on the recommendation, auxiliary reference signals for beams that are among beam prediction targets (block 1230). For example, the network entity (e.g., using communication manager 1408 and/or selection component 1410 depicted in FIG. 14) may select, based at least in part on the recommendation, auxiliary reference signals for beams that are among beam prediction targets, as described above.

As further shown in FIG. 12, in some aspects, process 1200 may include transmitting the auxiliary reference signals in the beams (block 1240). For example, the network entity (e.g., using communication manager 1408 and/or transmission component 1404 depicted in FIG. 14) may transmit the auxiliary reference signals in the beams, as described above.

Process 1200 may include additional aspects, such as any single aspect or any combination of aspects described below and/or in connection with one or more other processes described elsewhere herein.

In a first aspect, the recommendation includes a quantity of reference signal resources in the set of reference signal resources, and selecting the auxiliary reference signals includes selecting the auxiliary reference signals based at least in part on the quantity of the reference signal resources.

In a second aspect, alone or in combination with the first aspect, the recommendation includes a periodicity of reference signal resources in the set of reference signal resources, and selecting the auxiliary reference signals includes selecting the auxiliary reference signals based at least in part on the periodicity of the reference signal resources.

In a third aspect, alone or in combination with one or more of the first and second aspects, the recommendation includes a frequency domain density of reference signal resources in the set of reference signal resources, and selecting the auxiliary reference signals includes selecting the auxiliary reference signals based at least in part on the frequency domain density of the reference signal resources.

In a fourth aspect, alone or in combination with one or more of the first through third aspects, the recommendation includes a type of reference signal resource in the set of reference signal resources, and selecting the auxiliary reference signals includes selecting the auxiliary reference signals based at least in part on the type of reference signal resource.

In a fifth aspect, alone or in combination with one or more of the first through fourth aspects, the recommendation includes spatial associations between beam prediction targets and the auxiliary reference signals.

In a sixth aspect, alone or in combination with one or more of the first through fifth aspects, the spatial associations are based at least in part on a quantity of beam prediction targets having a greatest signal strength.

In a seventh aspect, alone or in combination with one or more of the first through sixth aspects, the beam prediction targets are associated with SP CSI-RSs.

In an eighth aspect, alone or in combination with one or more of the first through seventh aspects, the set of reference signal resources are a subset of SP CSI-RSs.

In a ninth aspect, alone or in combination with one or more of the first through eighth aspects, process 1200 includes receiving an updated recommendation, and transmitting a new set of auxiliary reference signals based at least in part on the updated recommendation.

In a tenth aspect, alone or in combination with one or more of the first through ninth aspects, receiving the updated recommendation includes receiving the updated recommendation via a MAC CE or UCI.

In an eleventh aspect, alone or in combination with one or more of the first through tenth aspects, receiving the recommendation includes receiving the recommendation with UE capability information during an initial access procedure.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE (e.g., UE 120, UE 820), or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the UE described in connection with FIG. 2. The communication manager 1308 may be, or be similar to, the communication manager 140 depicted in FIGS. 1 and 2. For example, in some aspects, the communication manager 1308 may be configured to perform one or more of the functions described as being performed by the communication manager 140. In some aspects, the communication manager 1308 may include the reception component 1302 and/or the transmission component 1304. The communication manager 1308 may include a prediction component 1310 and/or an evaluation component 1312, among other examples.

In some aspects, the apparatus 1300 may be configured to perform one or more operations described herein in connection with FIGS. 1-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The transmission component 1304 may transmit a recommendation of a set of reference signal resources for monitoring performance of beam prediction procedures. The reception component 1302 may receive a request to perform a beam prediction procedure from a network entity. The prediction component 1310 may perform the beam prediction procedure. The reception component 1302 may receive, in association with the recommendation, auxiliary reference signals in beams that are among beam prediction targets of the beam prediction procedure.

The evaluation component 1312 may compare beam predication targets and measurement results of the auxiliary reference signals. The transmission component 1304 may transmit an updated recommendation based at least in part on a result of the comparing.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network entity (e.g., network node 110, network entity 810), or a network entity may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 1408. The communication manager 1408 may control and/or otherwise manage one or more operations of the reception component 1402 and/or the transmission component 1404. In some aspects, the communication manager 1408 may include one or more antennas, a modem, a controller/processor, a memory, or a combination thereof, of the network entity described in connection with FIG. 2. The communication manager 1408 may be, or be similar to, the communication manager 150 depicted in FIGS. 1 and 2. For example, in some aspects, the communication manager 1408 may be configured to perform one or more of the functions described as being performed by the communication manager 150. In some aspects, the communication manager 1408 may include the reception component 1402 and/or the transmission component 1404. The communication manager 1408 may include a selection component 1410, among other examples.

In some aspects, the apparatus 1400 may be configured to perform one or more operations described herein in connection with FIGS. 1-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network entity described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network entity described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network entity described in connection with FIG. 2. In some aspects, the transmission component 1404 may be co-located with the reception component 1402 in a transceiver.

The reception component 1402 may receive a recommendation of a set of reference signal resources for a UE to use for monitoring performance of beam prediction procedures. The transmission component 1404 may transmit a request to perform a beam prediction procedure. The selection component 1410 may select, based at least in part on the recommendation, auxiliary reference signals for beams that are among beam prediction targets. The transmission component 1404 may transmit the auxiliary reference signals in the beams.

The reception component 1402 may receive an updated recommendation. The transmission component 1404 may transmit a new set of auxiliary reference signals based at least in part on the updated recommendation.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting a recommendation of a set of reference signal resources for monitoring performance of beam prediction procedures; receiving a request to perform a beam prediction procedure from a network entity; performing the beam prediction procedure; and receiving, in association with the recommendation, auxiliary reference signals in beams that are among beam prediction targets of the beam prediction procedure.

Aspect 2: The method of Aspect 1, wherein the recommendation includes a quantity of reference signal resources in the set of reference signal resources.

Aspect 3: The method of Aspect 1 or 2, wherein the recommendation includes a periodicity of reference signal resources in the set of reference signal resources.

Aspect 4: The method of any of Aspects 1-3, wherein the recommendation includes a frequency domain density of reference signal resources in the set of reference signal resources.

Aspect 5: The method of any of Aspects 1-4, wherein the recommendation includes a type of reference signal resources in the set of reference signal resources.

Aspect 6: The method of any of Aspects 1-5, wherein transmitting the recommendation includes transmitting the recommendation with UE capability information during an initial access procedure.

Aspect 7: The method of any of Aspects 1-6, wherein the recommendation includes spatial associations between beam prediction targets and the auxiliary reference signals.

Aspect 8: The method of Aspect 7, wherein the spatial associations are based at least in part on a quantity of beam prediction targets having a greatest signal strength.

Aspect 9: The method of Aspect 7 or 8, wherein the beam prediction targets are associated with semi-persistent channel state information reference signal resources.

Aspect 10: The method of any of Aspects 7-9, wherein the set of reference signal resources are a subset of semi-persistent channel state information reference signal resources.

Aspect 11: The method of any of Aspects 1-10, further comprising: comparing beam predication targets and measurement results of the auxiliary reference signals; and transmitting an updated recommendation based at least in part on a result of the comparing.

Aspect 12: The method of Aspect 11, wherein transmitting the updated recommendation includes transmitting the updated recommendation via a medium access control control element (MAC CE) or uplink control information.

Aspect 13: A method of wireless communication performed by a network entity, comprising: receiving a recommendation of a set of reference signal resources for a user equipment (UE) to use for monitoring performance of beam prediction procedures; transmitting a request to perform a beam prediction procedure; selecting, based at least in part on the recommendation, auxiliary reference signals for beams that are among beam prediction targets; and transmitting the auxiliary reference signals in the beams.

Aspect 14: The method of Aspect 13, wherein the recommendation includes a quantity of reference signal resources in the set of reference signal resources, and wherein selecting the auxiliary reference signals includes selecting the auxiliary reference signals based at least in part on the quantity of the reference signal resources.

Aspect 15: The method of Aspect 13 or 14, wherein the recommendation includes a periodicity of reference signal resources in the set of reference signal resources, and wherein selecting the auxiliary reference signals includes selecting the auxiliary reference signals based at least in part on the periodicity of the reference signal resources.

Aspect 16: The method of any of Aspects 13-15, wherein the recommendation includes a frequency domain density of reference signal resources in the set of reference signal resources, and wherein selecting the auxiliary reference signals includes selecting the auxiliary reference signals based at least in part on the frequency domain density of the reference signal resources.

Aspect 17: The method of any of Aspects 13-16, wherein the recommendation includes a type of reference signal resource in the set of reference signal resources, and wherein selecting the auxiliary reference signals includes selecting the auxiliary reference signals based at least in part on the type of reference signal resource.

Aspect 18: The method of any of Aspects 13-17, wherein the recommendation includes spatial associations between beam prediction targets and the auxiliary reference signals.

Aspect 19: The method of Aspect 18, wherein the spatial associations are based at least in part on a quantity of beam prediction targets having a greatest signal strength.

Aspect 20: The method of Aspect 18 or 19, wherein the beam prediction targets are associated with semi-persistent channel state information reference signal resources.

Aspect 21: The method of any of Aspects 18-20, wherein the set of reference signal resources are a subset of semi-persistent channel state information reference signal resources.

Aspect 22: The method of any of Aspects 13-21, further comprising: receiving an updated recommendation; and transmitting a new set of auxiliary reference signals based at least in part on the updated recommendation.

Aspect 23: The method of Aspect 22, wherein receiving the updated recommendation includes receiving the updated recommendation via a medium access control control element (MAC CE) or uplink control information.

Aspect 24: The method of any of Aspects 13-23, wherein receiving the recommendation includes receiving the recommendation with UE capability information during an initial access procedure.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communications at a user equipment (UE), comprising:
a processor;
memory coupled with the processor; and
instructions stored in the memory and executable by the processor to cause the apparatus to:
transmit a recommendation of a set of reference signal resources for monitoring performance of beam prediction procedures;
receive a request to perform a beam prediction procedure from a network entity;
perform the beam prediction procedure; and
receive, in association with the recommendation, auxiliary reference signals in beams that are among beam prediction targets of the beam prediction procedure.

2. The apparatus of claim 1, wherein the recommendation includes a quantity of reference signal resources in the set of reference signal resources.

3. The apparatus of claim 1, wherein the recommendation includes a periodicity of reference signal resources in the set of reference signal resources.

4. The apparatus of claim 1, wherein the recommendation includes a frequency domain density of reference signal resources in the set of reference signal resources.

5. The apparatus of claim 1, wherein the recommendation includes a type of reference signal resources in the set of reference signal resources.

6. The apparatus of claim 1, wherein the instructions, to transmit the recommendation, are executable by the processor to cause the apparatus to transmit the recommendation with UE capability information during an initial access procedure.

7. The apparatus of claim 1, wherein the recommendation includes spatial associations between beam prediction targets and the auxiliary reference signals.

8. The apparatus of claim 7, wherein the spatial associations are based at least in part on a quantity of beam prediction targets having a greatest signal strength.

9. The apparatus of claim 7, wherein the beam prediction targets are associated with semi-persistent channel state information reference signal resources.

10. The apparatus of claim 7, wherein the set of reference signal resources are a subset of semi-persistent channel state information reference signal resources.

11. The apparatus of claim 1, wherein the instructions are executable by the processor to cause the apparatus to:
compare beam predication targets and measurement results of the auxiliary reference signals; and
transmit an updated recommendation based at least in part on a result of the comparing.

12. The apparatus of claim 11, wherein the instructions, to transmit the updated recommendation, are executable by the processor to cause the apparatus to transmit the updated recommendation via a medium access control control element (MAC CE) or uplink control information.

13. An apparatus for wireless communications at a network entity, comprising:
a processor;
memory coupled with the processor; and
instructions stored in the memory and executable by the processor to cause the apparatus to:
receive a recommendation of a set of reference signal resources for a user equipment (UE) to use for monitoring performance of beam prediction procedures;
transmit a request to perform a beam prediction procedure;
select, based at least in part on the recommendation, auxiliary reference signals for beams that are among beam prediction targets; and
transmit the auxiliary reference signals in the beams.

14. The apparatus of claim 13, wherein the recommendation includes a quantity of reference signal resources in the set of reference signal resources, and wherein the instructions, to select the auxiliary reference signals, are executable to cause the apparatus to select the auxiliary reference signals based at least in part on the quantity of the reference signal resources.

15. The apparatus of claim 13, wherein the recommendation includes a periodicity of reference signal resources in the set of reference signal resources, and wherein the instructions, to select the auxiliary reference signals, are executable to cause the apparatus to select the auxiliary reference signals based at least in part on the periodicity of the reference signal resources.

16. The apparatus of claim 13, wherein the recommendation includes a frequency domain density of reference signal resources in the set of reference signal resources, and wherein the instructions, to select the auxiliary reference signals, are executable to cause the apparatus to select the auxiliary reference signals based at least in part on the frequency domain density of the reference signal resources.

17. The apparatus of claim 13, wherein the recommendation includes a type of reference signal resource in the set of reference signal resources, and wherein the instructions, to select the auxiliary reference signals, are executable to cause the apparatus to select the auxiliary reference signals based at least in part on the type of reference signal resource.

18. The apparatus of claim 13, wherein the recommendation includes spatial associations between beam prediction targets and the auxiliary reference signals.

19. The apparatus of claim 18, wherein the spatial associations are based at least in part on a quantity of beam prediction targets having a greatest signal strength.

20. The apparatus of claim 18, wherein the beam prediction targets are associated with semi-persistent channel state information reference signal resources.

21-30. (canceled)
